(19) United States
(12) Patent Application Publication
(10) Pub. No.: US 2011/0203006 A1
(43) Pub. Date: Aug. 18, 2011

(54) METHOD AND SYSTEM FOR DELIVERING CLOSED-AUDIENCE CONTENT TO A CLOSED MOBILE AUDIENCE

(75) Inventor: Kumar Gopalakrishnan, Mountain View, CA (US)

(73) Assignee: OPENWAVE SYSTEMS INC., Redwood City, CA (US)

(21) Appl. No.: 13/028,031

(22) Filed: Feb. 15, 2011

Related U.S. Application Data
(60) Provisional application No. 61/304,764, filed on Feb. 15, 2010.

(51) Int. Cl. G06F 15/16; G06F 21/24; H04L 12/14

(52) U.S. Cl. 726/29; 709/217; 705/400

(57) ABSTRACT

A method and system for delivering closed-audience content to a closed mobile audience is described. In one embodiment, a method for delivering closed-audience content to a closed mobile audience is described. The method for delivering closed-audience content to a closed mobile audience involves obtaining closed-audience content, establishing a closed mobile audience, identifying a mobile user or a mobile device as being part of the closed mobile audience, and delivering the closed-audience content to the mobile user or the mobile device. Other embodiments are also described.

### CROSS-REFERENCE TO RELATED APPLICATION

This application is entitled to the benefit of provisional U.S. Patent Application Ser. No. 61/304,764, filed Feb. 15, 2010, which is incorporated by reference herein.

### BACKGROUND

Advances in Internet and wireless technologies have triggered an exponential upsurge in the amount of content that is available to mobile users. However, delivering the content to mobile users poses challenges such as maintaining a high quality of service (QOS) in a limited bandwidth environment. For a closed mobile audience, additional challenges arise such as protecting the content from unauthorized access and effective accounting of content usage. Therefore, there is a need for a method and system for delivering content to a closed mobile audience that can effectively deliver and monetize mobile traffic and overcome these challenges.

### SUMMARY

Embodiments of a method are described. In one embodiment, a method for delivering closed-audience content to a closed mobile audience is described. The method for delivering closed-audience content to a closed mobile audience involves obtaining closed-audience content, establishing a closed mobile audience, identifying a mobile user or a mobile device as being part of the closed mobile audience, and delivering the closed-audience content to the mobile user or the mobile device. Other embodiments of a method are also described.

Embodiments of a system are also described. In one embodiment, a system for delivering closed-audience content to a closed mobile audience is described. The system includes a closed-audience content obtainer configured to obtain closed-audience content, a closed mobile audience establisher configured to establish a closed mobile audience, a closed mobile audience identifier configured to identify a mobile user or a mobile device as being part of the closed mobile audience, and a closed-audience content delivery module configured to deliver the closed-audience content to the mobile user or the mobile device. Other embodiments of a system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a content presentation system.

FIG. 2 depicts a schematic block diagram of another embodiment of a content presentation system.

FIG. 3 shows an exemplary content delivery optimizer.

FIG. 4 depicts an embodiment of a mobile audience manager.

FIGS. 5 and 6 show exemplary operations of the mobile audience manager depicted in FIG. 4.

FIGS. 7 and 8 depict embodiments of an interface that enables a closed mobile audience to access closed-audience content.

FIG. 9 shows an example content management interface.

FIG. 10 is a process flow diagram of a method for delivering closed-audience content to a closed mobile audience in accordance with an embodiment of the invention.

FIG. 11 depicts a computer that includes a processor, memory, and a communications interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

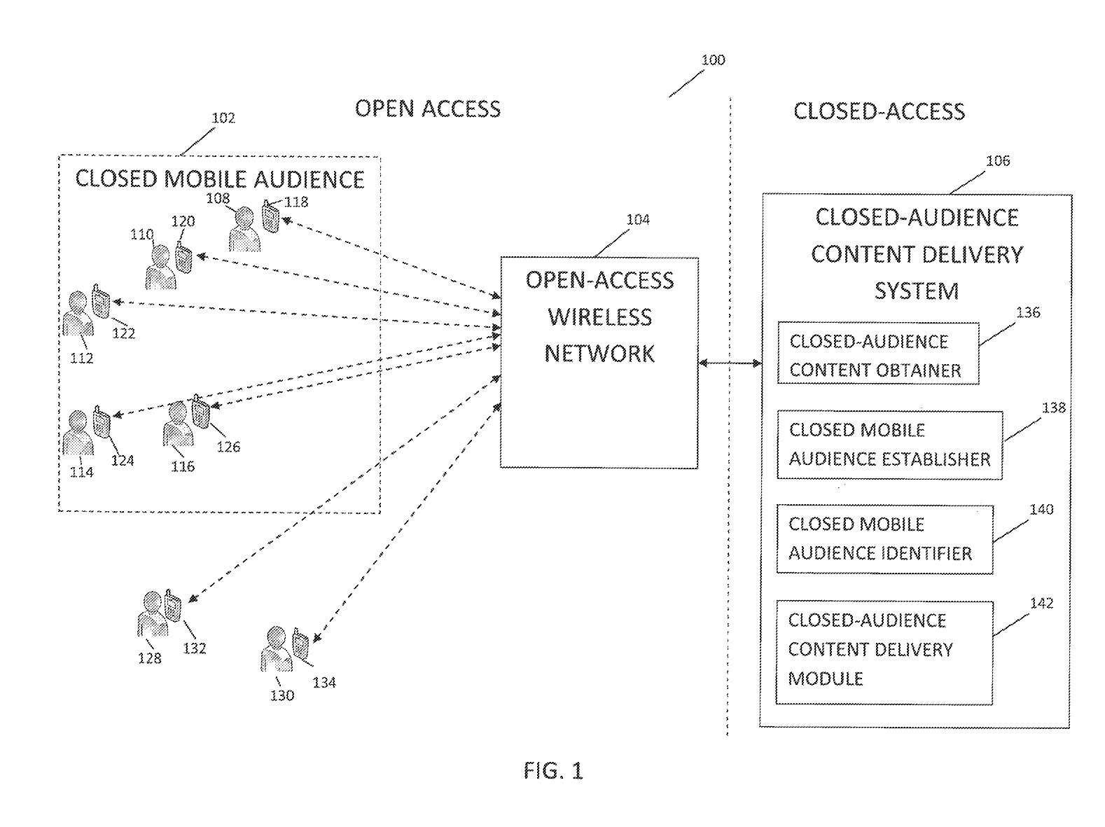

FIG. 1 depicts a schematic block diagram of one embodiment of a content presentation system 100. Content presented in the content presentation system may include information that an end user desires to watch, read, view, or listen to. In an embodiment, the content is a video clip that an end user desires to view and/or download. In another embodiment, the content is an online game that an end user participates in. The content may be in any data format or data formats. For example, the content may be text, webpage, image, audio, animation, or video data, or any combination thereof.

The content presentation system 100 depicted in FIG. 1 includes a closed mobile audience 102, an open-access wireless network 104, and a closed-audience content delivery system 106. In an embodiment, the term “closed” defines access that is confined to a limited set of participants. Closed-audience content is content that is only accessible to a limited audience. In the embodiment depicted in FIG. 1, closed-audience content at the closed-audience content delivery system is only accessible to the closed mobile audience. The open-access wireless network is openly accessible and the closed-audience content delivery system is closed accessible. In other words, the open-access wireless network is accessible to all of the mobile users and devices that are authorized to use the open-access wireless network while the closed-audience content delivery system is only accessible to the closed mobile audience. In an embodiment, all mobile devices with an active account with a mobile carrier have access to the open-access wireless network, e.g., all subscribers to a mobile service. However, only a subset of all of these mobile devices makes up the closed mobile audience that has access to the closed-audience content. Although the content presentation system is depicted and described with certain components and functionality, other embodiments of the content presentation system may include fewer or more components to implement less or more functionality.

The closed mobile audience 102 includes at least one mobile user and/or at least one mobile device. A mobile user may be a single person, multiple persons, other entity or entities. In an embodiment, a mobile user is a person that has an active account with a mobile service provider such as AT&T, Verizon, Sprint, or T-Mobile. In another embodiment, a mobile user is an employee of an enterprise, a member of an organization, or a participant in an event such as an industry trade show. Each mobile user is equipped with at least one mobile device that wirelessly communicates with the open-access wireless network 104 using electromagnetic signals such as radio frequency (RF) signals. The mobile device may access the close-audience content at the closed-audience content delivery system 106 in a content browser of the mobile device or in an application program of the mobile device. In an embodiment, the mobile device accesses the close-audience content via a web browser such as Mozilla Firefox, Microsoft Internet Explorer (IE), Google Chrome, or Apple Safari. In another embodiment, the mobile device accesses the close-audience content in a mobile application that is downloaded to the mobile device. The content browser or the application program that is used by the mobile device to access the closed-audience content may be provided to the mobile device by the closed-audience content delivery system. The mobile device may have a wide range of mobility and portability. In an embodiment, the mobile device is a handheld mobile device such as a cellular phone, a smartphone, a Personal Digital Assistant (PDA), an Enterprise digital assistant (EDA), or a handheld gaming device. In another embodiment, the mobile device is a portable computing device such as a laptop computer, a netbook computer, or a tablet computer. The mobile device supports various RF communications protocols, including without limitation, Institute of Electrical and Electronics Engineers (IEEE) 802.11, HiperLAN (High Performance Radio LAN), Global System for Mobile communications (GSM), Universal Mobile Telecommunications System (UMTS), Code Division Multiple Access (CDMA), Worldwide Interoperability for Microwave Access (WiMax) and communications protocols as defined by the 3rd Generation Partnership Project (3GPP) or the 3rd Generation Partnership Project 2 (3GPP2), 4G Long Term Evolution (LTE), IEEE 802.16 standards bodies. Although some wireless communications protocols are identified herein, it should be understood that present disclosure is not limited to the cited wireless communications protocols. In the embodiment depicted in FIG. 1, the closed mobile audience includes five mobile users 108, 110, 112, 114, 116. Each of the five mobile users communicates with the open-access wireless network via a smartphone 118, 120, 122, 124, 126.

In an embodiment, the closed mobile audience 102 is defined by affinities, membership affiliations, or subscription levels of the mobile user and/or the mobile device. The closed mobile audience may be established in a user-centric manner, in a device-centric manner, or in a combination of a user-centric manner and a device-centric manner. When the closed mobile audience is established in a user-centric manner, the closed mobile audience consists of one or more mobile users. For example, the closed mobile audience consists of registered attendees of a conference or selected employees of an enterprise who are authorized to access internal information of the enterprise. When the closed mobile audience is established in a device-centric manner, the closed mobile audience consists of one or more mobile devices. For example, the closed mobile audience consists of mobile handheld devices that are preconfigured and/or preauthorized to access restricted information of an event. When the closed mobile audience is established in the combination of a user-centric manner and a device-centric manner, the closed mobile audience consists of one or more mobile users and one or more mobile devices. For example, the closed mobile audience consists of mobile handheld devices that are preconfigured and/or preauthorized to access restricted information related to an event or selected employees of an enterprise that are authorized to access restricted information.

The open-access wireless network 104 is the communications channel between the closed mobile audience 102 and the closed-audience content delivery system 106. The open-access wireless network may have other users in addition to the closed mobile audience. In the embodiment depicted in FIG. 1, the open-access wireless network has two mobile users 128, 130 that are not part of the closed mobile audience. Each of the two mobile users 128, 130 communicates with the open-access wireless network using a smartphone 130, 134. The open-access wireless network can support various different RF communications protocols, including without limitation, IEEE 802.11, HiperLAN, GSM, UMTS, CDMA, WiMax and communications protocols as defined by 3GPP, 3GPP2, or IEEE 802.16.

The open-access wireless network 104 may communicate with the closed mobile audience 102 in a licensed radio frequency spectrum. In an embodiment, the open-access wireless network is a mobile carrier network from a mobile carrier such as AT&T, Verizon, Sprint, or T-Mobile. Alternatively, the open-access wireless network may communicate with the closed mobile audience in an unlicensed radio frequency spectrum such as industrial, scientific and medical (ISM) radio bands. For example, the open-access wireless network is a wireless local area network (WLAN) such as an IEEE 802.11 WLAN or a HiperLAN WLAN.

The closed-audience content delivery system 106 includes a closed-audience content obtainer 136 configured to obtain closed-audience content, a closed mobile audience establisher 138 configured to establish the closed mobile audience 102, a closed mobile audience identifier 140 configured to identify a mobile user or a mobile device as being part of the closed mobile audience, and a closed-audience content delivery module 142 configured to deliver the closed-audience content to the mobile user or the mobile device. In an embodiment, the closed-audience content delivery system is further configured to optimize content that is being delivered according to characteristics of the closed mobile audience, the open-access wireless network 104, and/or the closed-audience content. For example, the closed-audience content delivery system optimizes content that is being delivered according to characteristics of the closed mobile audience and the delivery expectation on the content from the closed mobile audience, channel conditions of the open-access wireless network, and/or the workload of the closed-audience delivery system. In another example, the closed-audience content delivery system performs one or more semantic modifications such as prepending, appending and/or inserting advertisements and other content to content that is being delivered.

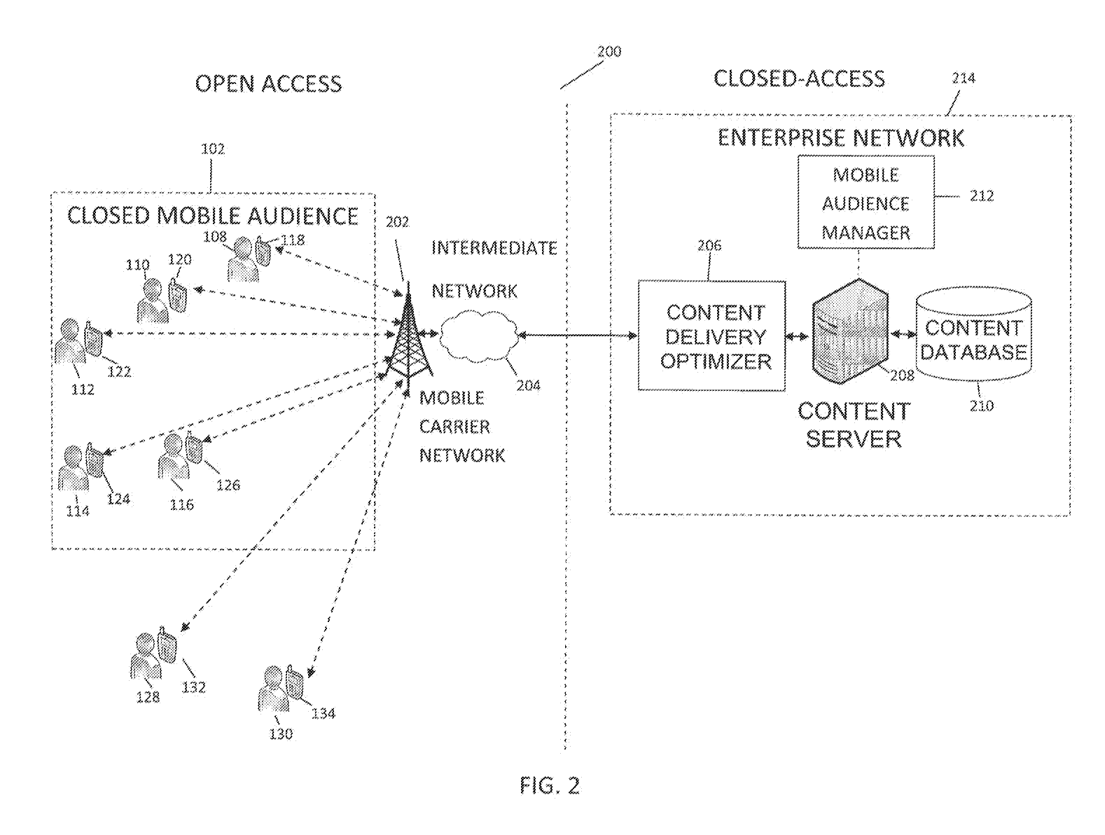

FIG. 2 depicts a schematic block diagram of another embodiment of a content presentation system 200. The content presentation system depicted in FIG. 2 includes a closed mobile audience 102, a mobile carrier network 202, an intermediate network 204, a content delivery optimizer 206, a content server 208, a content database 210, and a mobile audience manager 212. In the embodiment depicted in FIG. 2, the closed mobile audience includes five mobile users 108, 110, 112, 114, 116. Each of the five mobile users communicates with the mobile carrier network using a smartphone 118, 120, 122, 124, 126.

The mobile carrier network 202 is an embodiment of the open-access wireless network 104 depicted in FIG. 1. For example, the mobile carrier network is a cellular network from a mobile carrier such as AT&T, Verizon, Sprint, or T-Mobile. The mobile carrier network is openly accessible to subscribers of the mobile carrier network and their mobile devices. In other words, the mobile carrier network has other users in addition to the closed mobile audience 102. In the embodiment depicted in FIG. 2, the mobile carrier network has two mobile users 128, 130 that are not part of the closed mobile audience. Each of the two mobile users 128, 130 communicates with the mobile carrier network using a smartphone 130, 134.

The intermediate network 204 is located in the communications path between the mobile carrier network 202 and the content delivery optimizer 206. The intermediate network may be a wired network or a wireless network. In an embodiment, the intermediate network is an Internet Protocol (IP)-based network that may include a network of interconnected devise such as switches and routers. For example, the intermediate network is the Internet, which is also referred to as the “cloud.”

In some embodiments, the intermediate network 204 includes an Internet gateway that provides a gateway for communications between the mobile carrier network 202 and Internet-connected hosts and/or servers. The Internet gateway may include a Serving General Packet Radio Service (GPRS) Support Node (SGSN) and a Gateway GPRS Support Node (GGSN). The Internet gateway enables mobile devices to access multimedia content, such as Hyper Text Markup Language (HTML), compact HTML (cHTML), and extensible HTML (xHTML) stored on Internet-connected hosts and/or servers. For example, the Internet gateway is a Wireless Application Protocol (WAP) gateway that converts the WAP protocol used by the mobile carrier network to the Hypertext Transfer Protocol (HTTP) protocol used by the Internet. The Internet gateway may be part of the content delivery optimizer 206 instead of being part of the intermediate network.

The content delivery optimizer 206, the content server 208, the content database 210, and the mobile audience manager 212 are only accessible to mobile users and/or mobile devices that are part of the closed mobile audience 102. As depicted in FIG. 2, the content delivery optimizer, the content server, the mobile audience manager, and the content database are part of an enterprise network 214. The enterprise network is only accessible to mobile users and/or mobile devices that are part of the closed mobile audience. In an embodiment, the content delivery optimizer is located in the intermediate network 204 while the content server, the mobile audience manager, and the content database are part of an enterprise internal network. In another embodiment, the content delivery optimizer, the content server, the mobile audience manager, and the content database are all located in the intermediate network. The content delivery optimizer, the content server, the content database, and the mobile audience manager perform similar functions as the closed-audience delivery system 106 depicted in FIG. 1.

The content delivery optimizer 206 is configured to optimize closed-audience content according to characteristics of the closed mobile audience 102, the mobile carrier network 202, and/or the closed-audience content. For example, the content delivery optimizer optimizes live content on the fly and pre-optimizes fixed content.

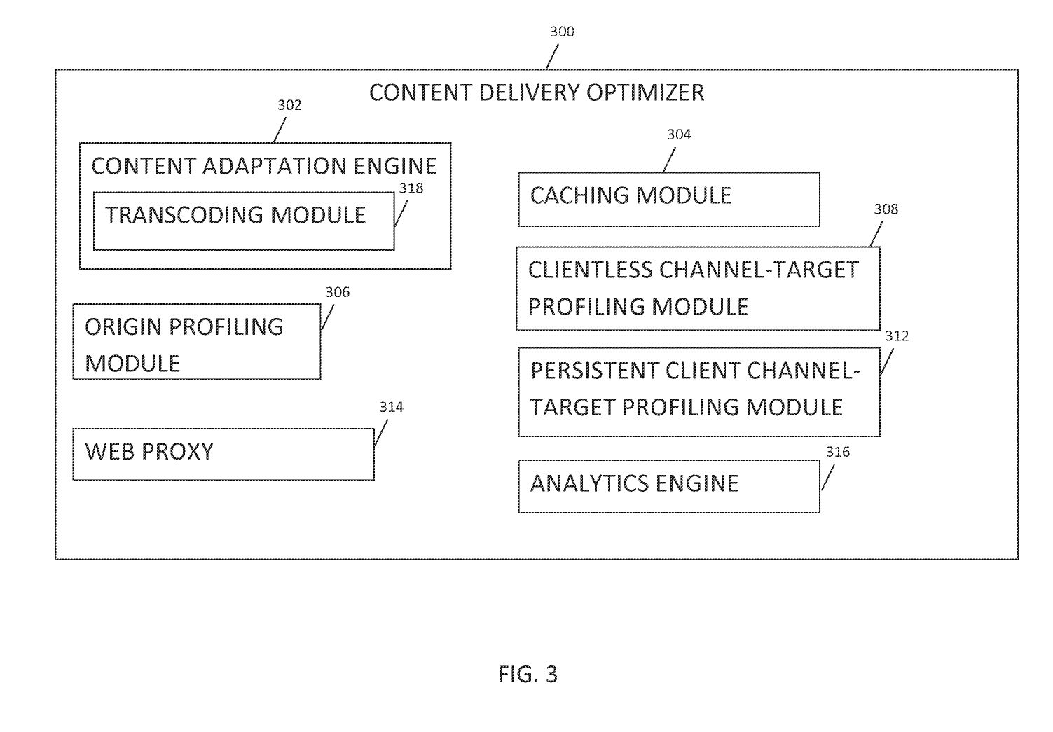

An exemplary embodiment of the content delivery optimizer 206 is shown in FIG. 3. The content delivery optimizer 300 in FIG. 3 includes a content adaptation engine 302, a caching module 304, an origin profiling module 306, a clientless channel-target profiling module 308, a persistent client channel-target profiling module 312, a web proxy 314, and an analytics engine 316.

The content adaptation engine 302 is configured to process closed-audience content based on information about the content, information about a mobile user and/or a mobile device to which the content is delivered, and information about the communications channel between the content and the mobile user or the mobile device. By adaptively processing the content being delivered, the content delivery is optimized. In the embodiment depicted in FIG. 3, the content adaptation engine includes a transcoding module 318 that is configured to encode content that is being delivered into encoded content, whose data size is usually smaller than the data size of the content that is being delivered. In an embodiment, the transcoding module encodes the content based on display physical dimensions and resolution of a mobile device, perceived bandwidth of the communications channel between the content and the mobile device, and supported codecs and delivery protocols of the mobile device. For example, the transcoding module performs content format conversion for various delivery protocols using tools from delivery protocol providers such as Microsoft, Apple, or Open source. The transcoding module may also be configured to encode the content that is being delivered into an encoded content that is more secure. By encoding the content that is being delivered into a smaller or more secure encoded content, the content delivery is optimized.

The caching module 304 is configured to cache a selected set of popular content from closed-audience content in the content database 210. Because the popularity of content can rapidly change in a short time span, the caching module may delete previously cached content or overwrite the previously cached content to cache newly popular content. By caching the popular content, the averaged time of fetching content from the content database is reduced.

The origin profiling module 306 is configured to provide the origin of content that is being delivered to the content delivery optimizer 300. The origin of the content defines the characteristics of the content. The characteristics of the content include information about the content such as content source quality, content duration, and content metadata. Content metadata may include data about information that is carried by the content or information about the environment in which the content situates. In an embodiment, metadata of a video content describes a web page in which the video content is embedded. Additionally, the characteristics of content include information about the usage of the content such as user expectation on the content such as QOS requirements and content consumption patterns on the content. Content consumption patterns may include content popularity information and content lifecycle information such as newness of the content, expiration date of the content, etc. In an embodiment, the origin profiling module includes a white list database of content origin Uniform Resource Locators (URLs) and URL patterns, which can be remotely updated and can be used to specify appropriate encoding and caching parameters of the content.

Information from the origin profiling module 306 can be used by the transcoding module 318 and the caching module 304 for content delivery optimization. In an embodiment, the transcoding module encodes content that is being delivered using encoding parameters such as the user expectation on the content, the content source quality, and the content duration. In another embodiment, the caching module uses information from the origin profiling module to pre-fetch data into the caching module. For example, the caching module selects a set of content for caching based on content popularity information from the content consumption pattern or the metadata of the content.

The clientless channel-target profiling module 308 is configured to maintain a database of capabilities of a mobile device and the communications channel between the mobile device and the closed-audience content. The capabilities of a mobile device and the communications channel include operating parameters of the mobile device and the communications channel such as codecs supported by the mobile device, network protocols supported by the mobile device and the communications channel, network speeds supported by the mobile device and the communications channel, screen dimensions of the mobile device, and screen resolution of the mobile device. The mobile device may include various different content browsers and each of the content browsers may support different codecs and network protocols. The transcoding module 318 may use the capabilities of the mobile device and the communications channel as encoding parameters for content that is being delivered. In an embodiment, capacities parameters of a mobile device are provided to the content delivery optimizer 300 by the manufacturer of the mobile device and are pre-stored in a database within the content delivery optimizer.

The persistent client channel-target profiling module 312 is configured to trap all of the traffic on network stacks of a mobile device to which the content is being delivered. Trapping all of the traffic on the network stack of a mobile device enables profiling of the protocols and applications that the mobile device uses to deliver and present the content. In an embodiment, the persistent client channel-target profiling module is integrated into a driver software or management software of a 3G modem. The web proxy 314 is configured to intercept all of the content that is being requested by a particular mobile user or a particular mobile device of the closed mobile audience 102.

The analytics engine 316 is configured to gather statistics information of content, a mobile user and/or a mobile device to which the content is being delivered, and the communications channel between the content and the mobile user or the mobile device. In an embodiment, the analytics engine 316 gathers statistics information from other components 302, 304, 306, 308, 312, 314 of the content delivery optimizer 300. The analytics engine may include a statistics information database and a database updating unit that continuously updates the statistics information database according to status changes that are reported by other components of the content delivery optimizer. The analytics may refine statistics information based on statistics algorithms.

For the delivery of close-audience content to the closed mobile audience 102, the content delivery optimizer 206, 300 depicted in FIGS. 2 and 3 can achieve a sound QOS under a limited wireless bandwidth. However, the content delivery optimizer depicted in FIGS. 2 and 3 can also be used in other networks for other audiences. In other words, the content delivery optimizer depicted in FIGS. 2 and 3 is not restricted to the closed-audience content and the closed mobile audience. In an embodiment, the content delivery optimizer is used to optimize the delivery of publicly accessible content over a WLAN or a wired network.

Referring back to FIG. 2, the content server 208 may be a web server, a video server, or any other type of content server. The content server is configured to serve the content to the closed mobile audience 102 over at least one delivery protocol. In an embodiment, the content server serves audio and video content over HTTP and/or real time streaming protocol (RTSP) or other similar protocols such as Real-time Transport Protocol (RTP) and Real Data Transport (RDT) from a content encoder or from pre-encoded content stored in the content database 210.

The content database 210 is configured to store the closed-audience content. In an embodiment, the content database includes a content encoder configured to encode the closed-audience content. In another embodiment, the content database stores pre-encoded closed-audience content. The content database may delete previously stored content or overwrite the previously stored content to store new content.

The mobile audience manager 212 is configured to establish the closed mobile audience 102 and to identify a mobile user or a mobile device as being part of the closed mobile audience. In the embodiment depicted in FIG. 2, the mobile audience manager is logically connected to the content server 208. However, in some embodiments the mobile audience manager is integrated into the content server or the content delivery optimizer 206.

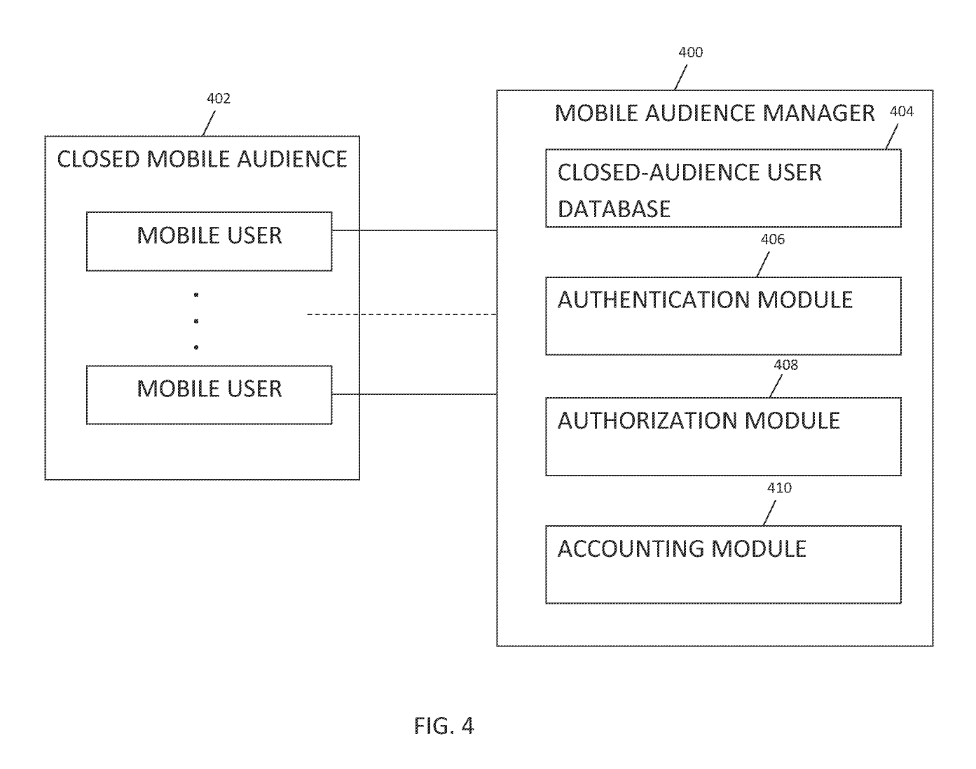

FIG. 4 depicts an exemplary mobile audience manager 400. In the embodiment depicted in FIG. 4, the mobile audience manager manages a closed mobile audience 402. The closed mobile audience includes multiple mobile users and each of the mobile users is equipped with at least one mobile device. The mobile audience manager includes a closed-audience user database 404, an authentication module 406, an authorization module 408, and an accounting module 410. In some embodiments, the authentication module, the authorization module, and the accounting module are integrated into a single Authentication, Authorization, and Accounting (AAA) element.

The closed-audience user database 404 is configured to store the closed mobile audience 402 that is established by the mobile audience manager 400. The closed-audience user database may be a distributed database or a centralized database.

The authentication module 406 is configured to authenticate a mobile user as being part of the closed mobile audience 402. In an embodiment, a mobile user sends identification information such as a password, a time token, or a digital certificate to the authentication module. The authentication module checks the identification information that is sent from the mobile user with information stored in the closed-audience user database 406 to authenticate the mobile user.

The authorization module 408 is configured to authorize the mobile user to access closed-audience content via a mobile device. In an embodiment, the authorization module sets an access policy for the mobile user to access the closed-audience content. The authorization module may temporarily grant the mobile user access to the closed-audience content for a short time duration such as two minutes to five minutes. The mobile user can access a snippet, a trailer, a teaser, or a glimpse of the closed-audience content before the short time duration expires. After the short time duration expires, the mobile user then has to pay, or otherwise gain authorization, to further access the content. When the content is a video clip, the authorization module may allow the mobile user to view the beginning or the end of the video clip, highlights of the video clip, or any other section of the video clip before complete authorization is granted.

The accounting module 410 is configured to account for the mobile user's access to the closed-audience content. The accounting module may designate some of the closed-audience content such as a trailer or a snippet of a video clip as free content. In an embodiment, the accounting module provides a tiered accounting structure to the mobile user. The tiered accounting structure presents different levels of access to the closed-audience content with different billing plans, which allows the mobile user to select a best-fit accounting scheme. For example, the accounting module provides billing options of different time durations of access such as all event pass, one day pass, trial pass, and pay per view. In another example, the accounting module provides billing options of different privileges of access such as premium access with high priority to access the content and plain access with regular or low priority to access the content.

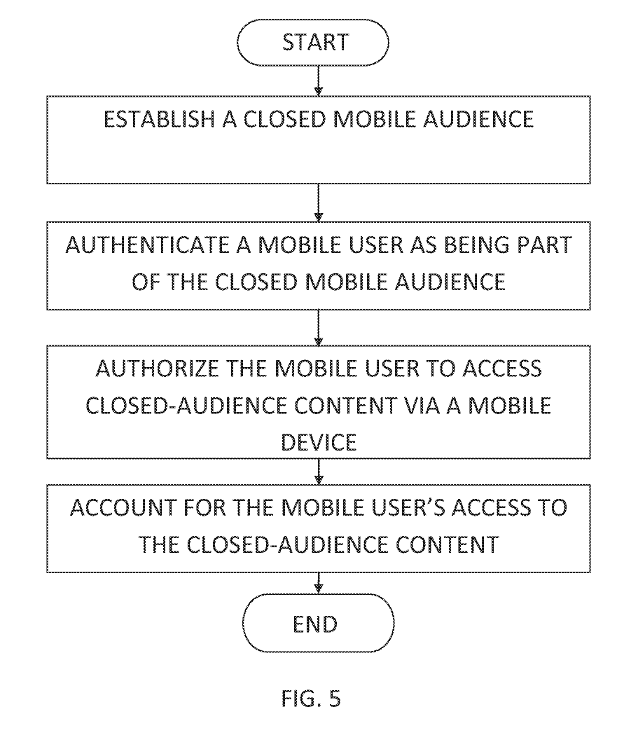

The closed-audience user database 404, the authentication module 406, the authorization module 408, and the accounting module 410 depicted in FIG. 4 can protect closed-audience content from unauthorized access and effectively accounts for content usage. An exemplary operation of the mobile audience manager 400 depicted in FIG. 4 is depicted with reference to FIG. 5. Firstly, the mobile audience manager establishes a closed mobile audience. When a mobile user makes a request for closed-audience content, the authentication module determines whether or not the mobile user is part of the closed mobile audience. If the mobile user is determined to be part of the closed mobile audience, the authorization module authorizes the mobile user to access the closed-audience content via a mobile device. The accounting module accounts for the mobile user's access to the closed-audience content.

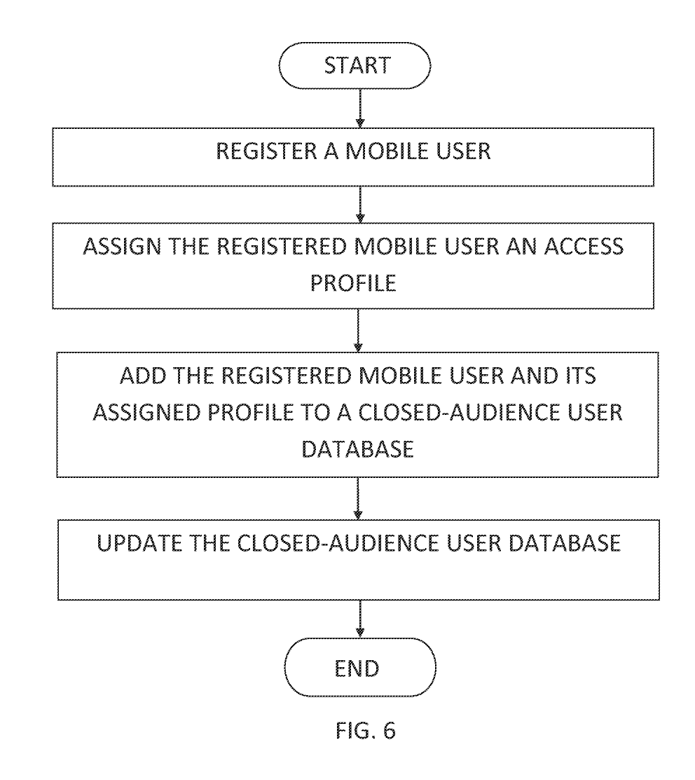

Another exemplary operation of the mobile audience manager 400 depicted in FIG. 4 is depicted with reference to FIG. 6. The mobile audience manager registers a mobile user and assigns the mobile user an access profile. Then the mobile audience manager adds the registered mobile user and its assigned profile to the closed-audience user database 404. The mobile audience manager may periodically update the closed-audience user database.

In some embodiments, the mobile audience manager 400 does not register a mobile user or assign the mobile user an access profile before the mobile user accesses closed-audience content. In an embodiment, the mobile user is allowed to sample the closed-audience content for a limited time span before being prompted to complete a mandatory registration process. In another embodiment, the mobile user has access to free content within the closed-audience content without logging in as a member of the closed mobile audience 402.

Although the mobile audience manager 400 depicted in FIG. 4 is described with respect to a mobile user, the description of the mobile audience manager is also applicable to a mobile device or to a combination of a mobile user and a mobile device. In other words, the mobile audience manager manages any closed mobile audience that can be established in a user-centric manner, in a device-centric manner, or in a combination of a user-centric manner and a device-centric manner.

Referring back to FIG. 2, the closed-audience content may be streamed to members of the closed mobile audience 102 or downloaded as a file and then used (e.g., played out) by members of the closed mobile audience. The closed-audience content can be delivered to the closed mobile audience in any format. For example, the closed-audience content is delivered to the closed mobile audience in a content file, in a web page, or in a mobile message. In an embodiment, the mobile carrier network 202 or the enterprise network 214 includes a multimedia message service center (MMSC) that provides Multimedia Messaging Service (MMS). The closed-audience content, which may include webpage, audio, video, image, and/or text data, can be delivered to the closed mobile audience in a multimedia message using the MMS.

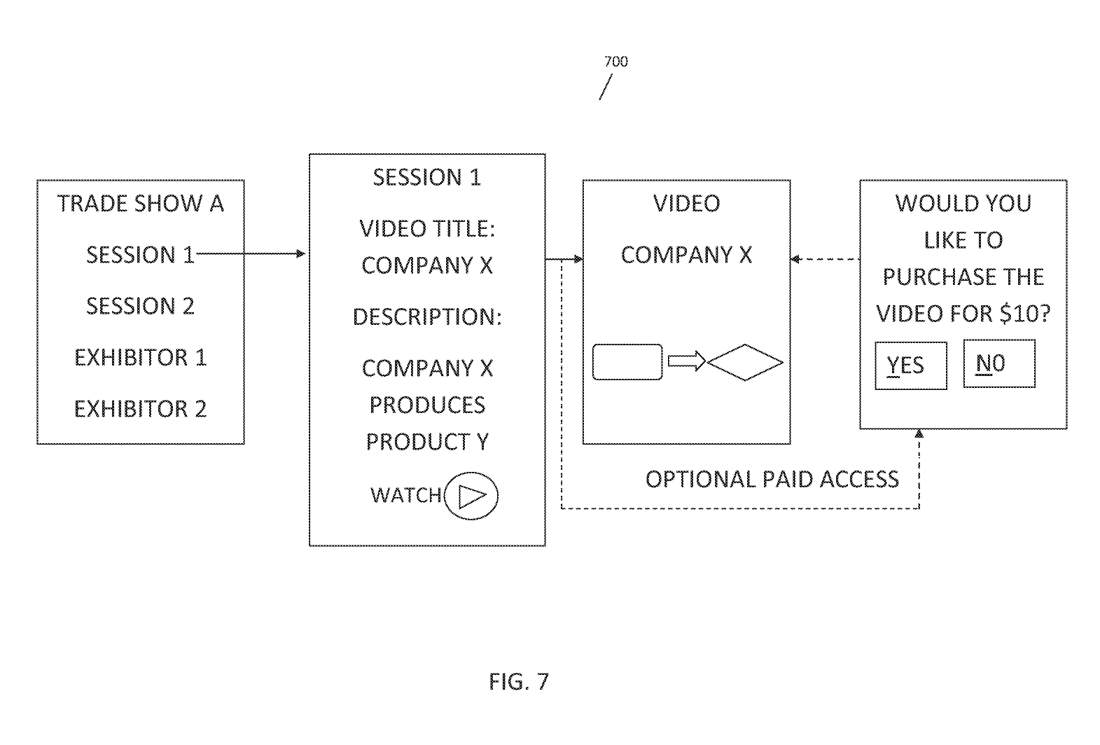

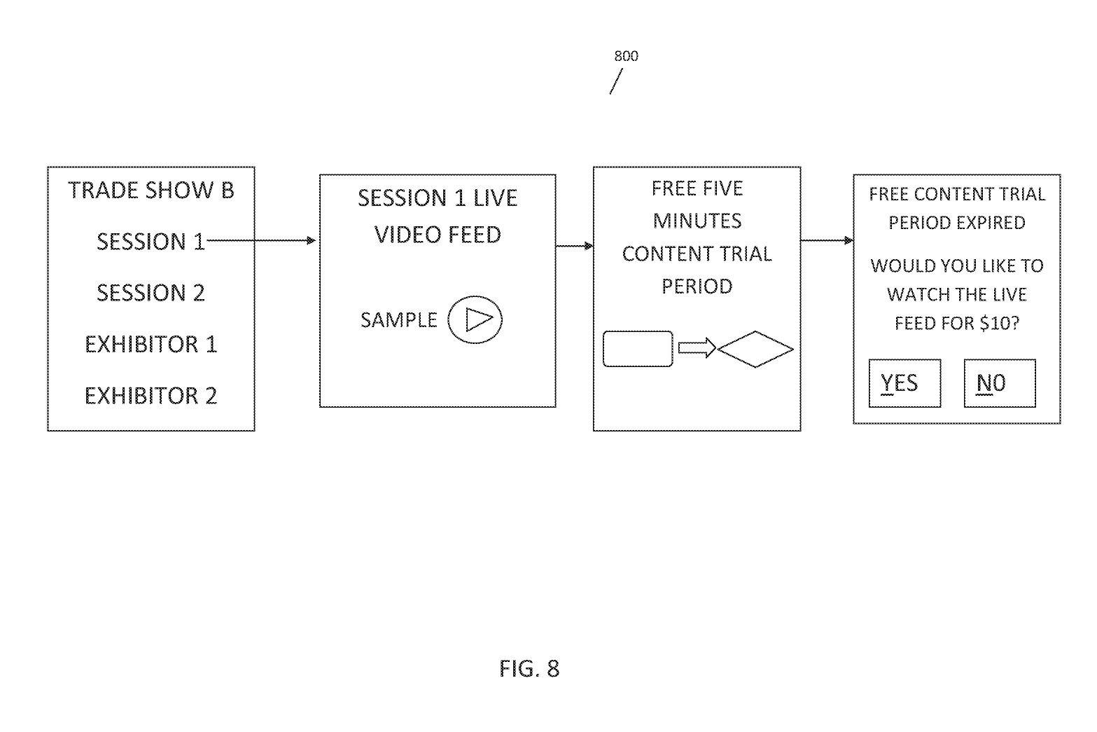

In the content presentation systems 100, 200 depicted in FIGS. 1 and 2, the closed-audience content may be presented to a mobile user via a website. The closed mobile audience 102 browses the website to identify and access the closed-audience content. In this case, an interface is provided to the closed mobile audience to identify and access the closed-audience content presented in the website. Two example interfaces 700, 800 are depicted in FIGS. 7 and 8.

In the example interface 700 depicted in FIG. 7, closed-audience content from session 1, session 2, exhibitor 1, and exhibitor 2 of a trade show “A” is available to a closed mobile audience. The closed-audience content from session 1 is a video titled “company x” with a description “company x produces product y.” A watch button is provided for streaming the identified video in a website to the closed mobile audience. The video from session 1 may be free to the closed mobile audience. Alternatively, an optional pay-per-view access to the video from session 1 is provided so that the closed mobile audience can access the video after purchasing the video at a cost of ten dollars.

In the example interface 800 depicted in FIG. 8, closed-audience content from session 1, session 2, exhibitor 1, and exhibitor 2 of a trade show “B” is available to a closed mobile audience. The closed-audience content from session 1 is a live video feed from session 1. A sample button is provided for streaming the live video feed to the closed mobile audience for a free content trial period of five minutes. A warning message such as “Free 5 minutes content trial period” is displayed along with the live video feed. After the free content trial period of five minutes expires, another warning message, such as “free content trial period expired,” is displayed and the closed mobile audience can further access the live video feed after purchasing the live video feed at a cost of ten dollars.

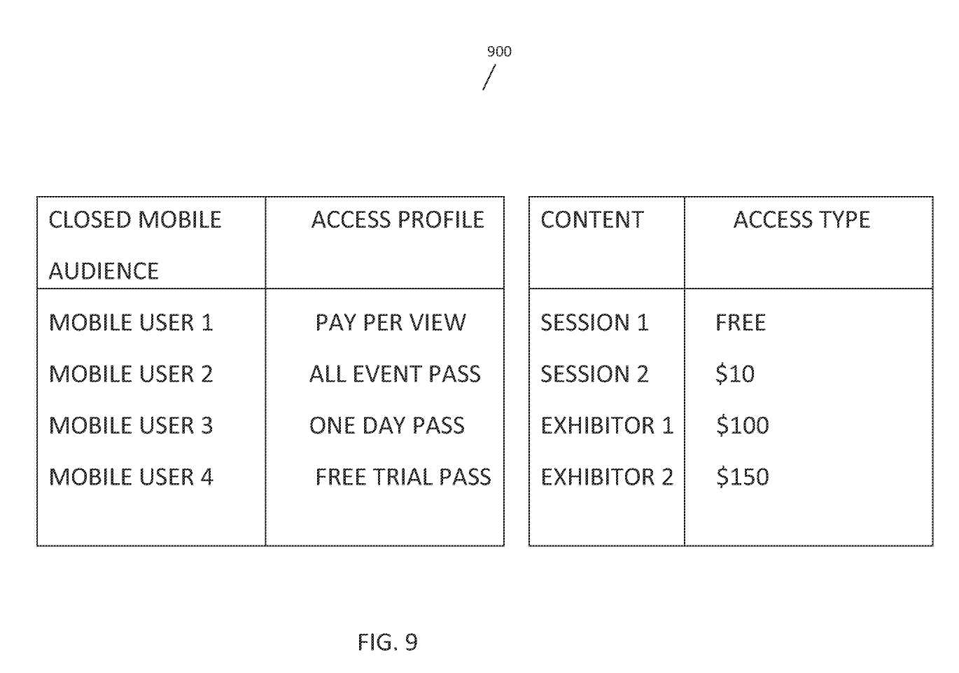

A content management interface to manage the closed-audience content may be provided to the content presentation systems 100, 200 depicted in FIGS. 1 and 2. The content management interface may be a webpage or a website. An example content management interface 900 is depicted in FIG. 9. The content management interface lists a closed mobile audience and closed-audience content for an event that lasts for more than one day. The closed mobile audience includes mobile users 1, 2, 3, and 4. Mobile user 1 has a content access profile of pay per view, which means that mobile user 1's access to content of the event is charged individually for each accessed piece of content. Mobile user 2 has a content access profile of all event pass, which means that mobile user 2 has access to all of the content of the event for the duration of the entire event. Mobile user 3 has a content access profile of one day pass, which means that mobile user 3 has access to all of the content of the event only for one day. Mobile user 4 has a content access profile of free trial pass, which means that mobile user 4 has access to all of the content in the event only for a limited trial period. The closed-audience content includes content from session 1, session 2, exhibitor 1, and exhibitor 2. Content from session 1 is free for all of the mobile users. Content from session 2 can be accessed for a price of ten dollars. Content from exhibitor 1 can be accessed a price of one hundred dollars. Content from exhibitor 2 can be accessed for a price of two hundred dollars.

In an embodiment, an interface for uploading content is provided for the content presentation systems 100, 200 depicted in FIGS. 1 and 2. The interface may be accessible only to the closed-audience content delivery system 106 depicted in FIG. 1 and the enterprise network 214 depicted in FIG. 2. For example, an enterprise allows only internal content management agents to upload content to an enterprise website. However, the interface for uploading content may be also available to an external entity. An external entity that uploads content may be compensated or charged by the content presentation systems depicted in FIGS. 1 and 2. For example, an exhibitor that uploads content to a trade show website for promotional purposes can be charged a fee for each uploaded content item by the accounting module 410 depicted in FIG. 4.

The content presentation systems 100, 200 depicted in FIGS. 1 and 2 can be used by an enterprise to effectively deliver and monetize mobile traffic. In an embodiment, a conference organizer sets up a conference website to present video clips and live video feeds of conference sessions and exhibitors to participants of the conference. After purchasing a conference pass at the conference website, a participant of the conference can access the video clips and the live video feeds for the entire duration of the conference using their mobile devices. An exhibitor at the conference can upload its own content to the conference website for promotional purposes after paying an advertising fee at the conference website. Therefore, the conference website becomes a revenue generator for the conference organizer. For the participants of the conference, such a content delivery system enables the participants to have wider access to content of the conference and as a result, to have a better conference experience.

In another embodiment, a corporation sets up an employee training website to present training materials such as training videos, documents, examinations, and/or interactive applications to employees of the corporation. The employees of the corporation can access the training materials in the employee training website anytime anywhere using their mobile devices. The employees of the corporation can upload their own content to the employee training website using their mobile devices. Therefore, the employee training website becomes an effective employee training portal for the corporation. For the employees of the corporation, such an employee training website enables the employees to have wider access to the training materials and as a result, to have a more flexible training experience.

In another embodiment, an organizer of a sports event such as the Olympics sets up a sports event website to present sports event content such as audio, video clips and/or live video feeds of the sports event to an audience of the sports event. After purchasing an event pass at the sports event website, a member of the audience can access the sports event content using its mobile device. Using such a closed-audience content delivery system, the sports event website can become a revenue generator for the organizer of the sports event. For the audience of the sports event, such a sports event website enables the audience to have wider access to content of the sports event and as a result, to have a better event experience.

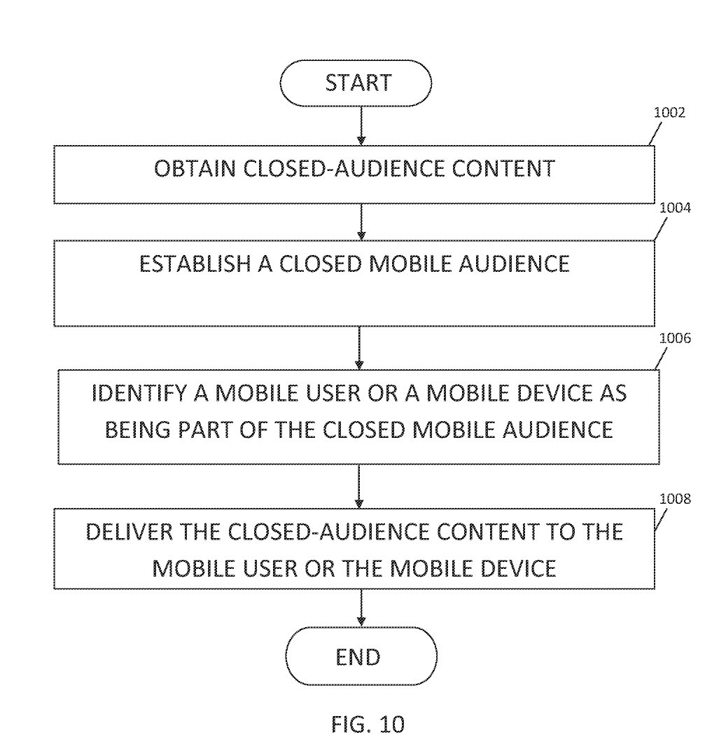

FIG. 10 is a process flow diagram of a method for delivering closed-audience content to a closed mobile audience in accordance with an embodiment of the invention. At block 1002, closed-audience content is obtained. At block 1004, a closed mobile audience is established. At block 1006, a mobile user or a mobile device is identified as being part of the closed mobile audience. At block 1008, the closed-audience content is delivered to the mobile user or the mobile device.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In an embodiment, at least one of the functionality of the closed-audience content delivery system 106 depicted in FIG. 1, the functionality of the content delivery optimizer 206 depicted in FIG. 2, the functionality of the content server 208 depicted in FIG. 2, or the functionality of the mobile audience manager 212 depicted in FIG. 2, is performed by a computer that executes computer readable instructions. In another embodiment, the functionality of the content delivery optimizer, the content server, and the mobile audience manager depicted in FIG. 2 is executed by three different computers that are distributed across the system 200 depicted in FIG. 2. In another embodiment, the functionality of the content delivery optimizer, the content server, and the mobile audience manager depicted in FIG. 2 is executed by a single computer that is located at the enterprise network 214 depicted in FIG. 2.

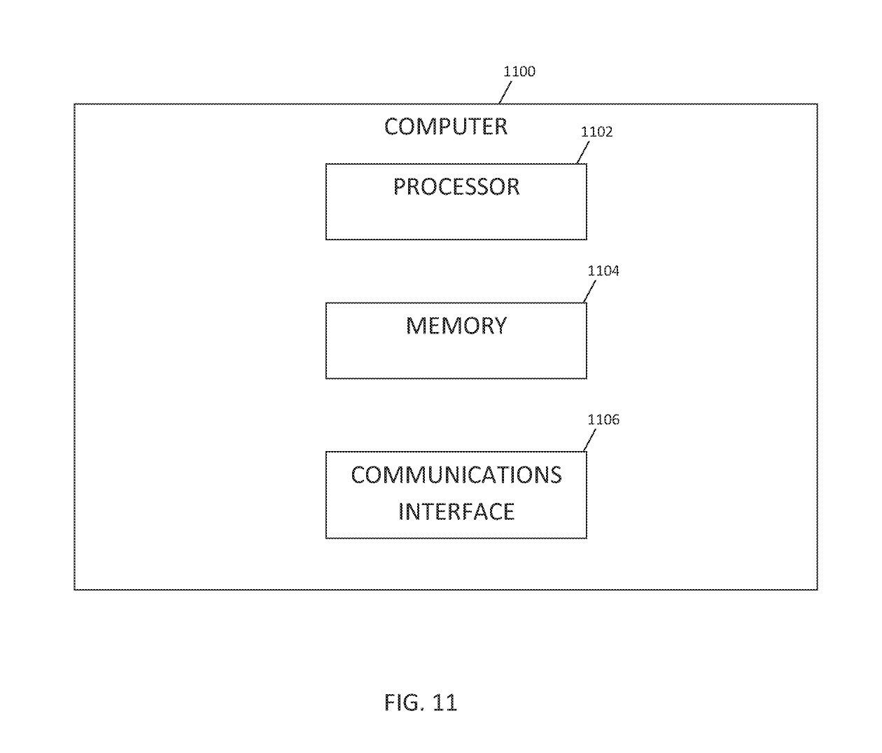

FIG. 11 depicts a computer 1100 that includes a processor 1102, memory 1104, and a communications interface 1106. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via communications protocols, for example, via the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is preliminarily claimed is:

1. A method for delivering closed-audience content to a closed mobile audience, the method comprising:
obtaining closed-audience content;
establishing a closed mobile audience;
identifying a mobile user or a mobile device as being part of the closed mobile audience; and
delivering the closed-audience content to the mobile user or the mobile device.

2. The method of claim 1 further comprising providing a content trial period to the closed mobile audience so that the closed mobile audience accesses at least part of the closed-audience content free of charge during the content trial period.

3. The method of claim 1, wherein delivering the closed-audience content comprises delivering the closed-audience content in a multimedia message.

4. The method of claim 1 further comprising:
authorizing the mobile user or the mobile device to access the closed-audience content; and
accounting for access to the closed-audience content of the mobile user or the mobile device.

5. The method of claim 1 further comprising charging for adding additional content to the closed-audience content.

6. The method of claim 1 further comprising optimizing the closed-audience content for delivery.

7. The method of claim 6, wherein optimizing the closed-audience content for delivery comprising optimizing the closed-audience content using characteristics of the mobile user or the mobile device.

8. The method of claim 6, wherein optimizing the closed-audience content for delivery comprising optimizing the closed-audience content using characteristics of the closed-audience content.

9. The method of claim 1, wherein delivering the closed-audience content comprises delivering the closed-audience content via an open-access wireless network.

10. The method of claim 9 further comprising optimizing the closed-audience content using characteristics of the open-access wireless network.

11. A system for delivering closed-audience content to a closed mobile audience, the system comprising:
a closed-audience content obtainer configured to obtain closed-audience content;
a closed mobile audience establisher configured to establish a closed mobile audience;
a closed mobile audience identifier configured to identify a mobile user or a mobile device as being part of the closed mobile audience; and
a closed-audience content delivery module configured to deliver the closed-audience content to the mobile user or the mobile device.

12. The system of claim 11 further comprising a mobile audience manager configured to provide a content trial period to the closed mobile audience so that the closed mobile audience accesses at least part of the closed-audience content free of charge during the content trial period.

13. The system of claim 11, wherein the closed-audience content delivery module is further configured to deliver the closed-audience content in a multimedia message.

14. The system of claim 11 further comprising:
an authorization module configured to authorize the mobile user or the mobile device to access the closed-audience content; and
an accounting module configured to account for access to the closed-audience content of the mobile user or the mobile device.

15. The system of claim 11 further comprising an accounting module configured to charge for adding additional content to the closed-audience content.

16. The system of claim 11 further comprising a content delivery optimizer configured to optimize the closed-audience content for delivery.

17. The system of claim 16, wherein the content delivery optimizer is further configured to optimize the closed-audience content using characteristics of the mobile user or the mobile device.

18. The system of claim 16, wherein the content delivery optimizer is further configured to optimize the closed-audience content using characteristics of the closed-audience content.

19. The system of claim 11, wherein the closed-audience content is delivered via an open-access wireless network.

20. The system of claim 19 further comprising a content delivery optimizer configured to optimize the closed-audience content using characteristics of the open-access wireless network.

21. An enterprise network system for delivering closed-audience content to a closed mobile audience, the enterprise network system comprising:
a closed-audience content database configured to store closed-audience content;
a mobile audience manager configured to establish a closed mobile audience and to identify a mobile user or a mobile device as being part of the closed mobile audience;
a content server configured to serve the closed-audience content to the mobile user or the mobile device over a delivery protocol; and
a content delivery optimizer configured to optimize the closed-audience content for delivery over an open-access wireless network.

22. A content presentation system comprising:
an open-access wireless network;
a set of mobile users or mobile devices that communicate via the open-access wireless network, wherein a subset of the set of mobile users or mobile devices forms a closed mobile audience; and
a closed-audience delivery system configured to obtain closed-audience content, to establish and to manage the closed mobile audience, to identify a mobile user or a mobile device as being part of the closed mobile audience, and to deliver the closed-audience content to the mobile user or the mobile device over the open-access wireless network.
